(19) United States
(12) Patent Application Publication
(10) Pub. No.: US 2024/0317013 A1
(43) Pub. Date: Sep. 26, 2024

(54) METHOD FOR OPERATING A DAMPER VALVE FOR CONTROLLING A DAMPER FORCE OF A DAMPER

(71) Applicant: Dr. Ing. H.C. F. Porshche Aktiengesellschaft, Stuttgart (DE)

(72) Inventor: Andreas Freuer, Ludwigsburg (DE)

(73) Assignee: Dr. Ing. H.C. F. Porsche Aktiengesellschaft, Stuttgart (DE)

(21) Appl. No.: 18/433,644

(22) Filed: Feb. 6, 2024

(30) Foreign Application Priority Data
Mar. 21, 2023 (DE) 10 2023 107 019.3

(51) Int. Cl. B60G 17/08; B60G 13/08; B60G 17/015; B60G 17/0165; B60G 17/018

(52) U.S. Cl. CPC B60G 17/08; B60G 13/08; B60G 17/0152; B60G 17/0165; B60G 17/018; B60G 2202/23; B60G 2204/62; B60G 2206/41; B60G 2400/5182; B60G 2400/7162; B60G 2500/104; B60G 2500/11; B60G 2600/182; B60G 2600/26; B60G 2800/162; B60G 2800/916

(57) ABSTRACT

A method for operating a damper valve in order to control a damper force of a damper in an active chassis of a vehicle, wherein the damper valve includes a pilot valve for controlling a main spool. The method includes determining a target pressure necessary for a target damper force, in a first damper chamber of the damper; determining a valve flow through a damper valve inlet of the damper valve on the basis of a damper flow, generated by a damper movement, from the first damper chamber and on the basis of a measured pump flow of a pump; determining a main spool opening distance in such a way that, with an applied main spool flow through the main spool opening distance, the target pressure is present as the back pressure in the first damper chamber.

### CROSS-REFERENCE TO RELATED APPLICATION

This application claims priority to German Patent Application No. 10 2023 107 019.3, filed Mar. 21, 2023, the content of such application being incorporated by reference herein in its entirety.

### FIELD OF THE INVENTION

The present invention relates to a method for operating a damper valve in order to control a damper force of a damper, in particular a damper in an active chassis of a vehicle.

### BACKGROUND OF THE INVENTION

In order to increase the driving comfort and the driving safety of vehicles, so-called active or semi-active dampers are used more and more frequently. By means of these dampers, the damper force can be adapted to various driving situations or wishes of the driver.

In order to set the force to be generated, electromagnetic damper valves are usually used, wherein the force control is performed via the current feed to electromagnets in the damper valves. In so doing, characteristic maps, which have been determined for the characteristic of a corresponding damper valve, are used to translate a force requirement into a corresponding current feed to the damper valves and to thus be able to set the force. For example, patent document DE 197 222 16 A1, which is incorporated by reference herein, discloses a damper valve having an electromagnetically actuated prestage valve for controlling a main stage valve. In this case, a setting of the prestage valve based on different characteristic maps is described.

However, by means of such a procedure, no force control in the actual sense can be performed since an actual value of the provided force, which is currently detected due to corresponding driving situations and external influences, such as temperature fluctuations and associated changes in the volume of the damper medium, is not taken into account.

Document DE 690 138 17 T2, which is incorporated by reference herein, furthermore discloses a damper valve comprising an electromagnetically actuated pilot valve for controlling a valve element of a control piston valve. In this case, it is described that a compensation coefficient for compensating electrical target currents is determined based on an oil temperature. In this way, at least one temperature dependence of the damper medium can be taken into account.

### SUMMARY OF THE INVENTION

Based on the presented prior art, described herein is a method that improves the control quality of an active damper and eliminates the above-presented disadvantages of previous methods, and thereby enables a true control of the damper force due to an actual-target deviation. By virtue of the method, a particularly energy-efficient control of the damper force can be carried out.

The method according to aspects of the invention for operating a damper valve with a pilot valve for controlling a main spool comprises several steps. First, a target pressure, necessary for a target damper force, in a first damper chamber of the damper is determined. Furthermore, a flow of the damper medium through a damper valve inlet of the damper valve, also referred to as a valve flow within the scope of this application, is determined on the basis of a damper flow, generated by a damper movement, from the first damper chamber and on the basis of a measured pump flow of a pump. The flow of the damper medium (damper flow) generated by the damper movement and flowing from the first damper chamber is dependent on the corresponding, induced movement of a piston in a cylinder of the damper and is therefore also to be understood as a disturbance variable within the scope of this application.

Furthermore, a main spool opening distance is determined in such a way that, with an applied main spool flow through the main spool opening distance, the target pressure forms as the back pressure in the first damper chamber. Accordingly, the main spool opening distance determines how large the main spool flow is that flows through a main spool opening between the main spool and a housing of the damper valve. The main spool opening distance thus determines the pressure of a main spool volume, limited by the main spool, in the damper valve and thus also the pressure in the first damper chamber.

Furthermore, a pilot valve flow is determined, which, at the target pressure to be set, passes via an inlet throttle in the main spool to the pilot valve and at which the main spool is in a force equilibrium. A force equilibrium within the scope of the application is understood to mean that the forces acting on the main spool are balanced so that the latter is in a particular position.

In a further method step, a pilot valve opening distance is determined on the basis of the calculated pilot valve flow. Accordingly, the pilot valve opening distance, which defines the flow through a pilot valve opening between the main spool and the pilot valve, is determined in such a way that the main spool is in force equilibrium.

From the determined main spool opening distance and the pilot valve opening distance, an armature position is subsequently determined in a further method step. The armature position is in this case settable by an actuator of the damper valve and is accordingly set in a further method step. The pilot valve opening distance and, accordingly, the main spool opening distance are defined by the armature position. Thus, by setting the armature position, the pressure in the first damper chamber can be set.

By means of the method according to aspects of the invention, deviations of the actual force from the predetermined target force as a result of external influences, such as the ambient temperature, component tolerances and/or the like, can be adjusted. Furthermore, for providing the target force, two degrees of freedom are available, namely, on the one hand, the setting of the pump flow and, on the other hand, a setting of the main spool opening distance. Thus, an operational strategy (control strategy) of the damper force that is consumption-optimized for the driving situation can be implemented from these two degrees of freedom.

In an advantageous embodiment of the invention, a provided actual force of the damper is determined on the basis of a pressure measured at the pump, of a damper movement, and/or of a temperature of the damper medium, wherein, in a particularly preferred embodiment, a control of the armature position and thus of the correspondingly provided actuator is performed on the basis of a deviation of the measured actual force from the predetermined target force. The detection of the actual force on the basis of a pressure measured in the pump, in particular taking into account the temperature of the damper medium, allows an accurate determination of the actual variable and thus contributes to a high control quality.

In a preferred embodiment of the invention, the actuator is designed as an electromagnet so that the setting of the armature position takes place by means of the electromagnet. Electromagnets are capable of exerting very precise forces and of being set highly dynamically at low energy consumption. The magnetic force for an armature position to be set is preferably calculated via a force equilibrium at the armature. Particularly preferably, the determination of the magnet valve current of the pilot valve, which leads to a magnetic force applied by the electromagnet, takes place on the basis of at least one characteristic map. Here, the use of a characteristic map is possible without any loss in terms of control accuracy since the setting of the magnetic force for the movement of the armature takes place independently of the temperature or other external factors and the requirement of the armature position to be set can thus be clearly translated into a magnetic force.

In a further preferred embodiment of the method according to aspects of the invention, a specification of the pump flow is determined as a function of the target force to be provided, of a driving situation of a vehicle comprising the damper, and/or of a damper movement. The damper movement preferably comprises both the gradient, i.e., the change and thus the dynamics of the movement, and the magnitude of the movement. A pump flow can be determined on the basis of the parameters given. Preferably determined in this case is a pump flow that is as little as possible and nonetheless allows sufficiently good control of the damper force by a corresponding setting of the armature position of the damper valve. Through a low pump flow, the pump and thus the damper system can be operated in a consumption-optimal manner.

Advantageous is also an embodiment of the invention in which the target pressure determined via a static pressure in a second damper chamber, a target damper force to be set, and a piston surface between the first and second damper chambers. In this way, a target pressure that is as exact as possible can be determined in order to use the damper as optimally as possible.

In so doing, the static pressure is preferably set as a function of an ambient temperature and a position of a piston in a cylinder of the damper. Due to different temperatures, an increase and a decrease of the volume of the damper medium can occur. Likewise, depending on the position of the damper, a piston rod of the piston occupies volume within the cylinder of the damper and thus influences the static pressure of the damper medium. In order to keep the influences on the control of the damper force as low as possible, such changes are taken into account accordingly and the static pressure is adjusted.

### BRIEF DESCRIPTION OF THE DRAWINGS

The invention is explained below in greater detail with reference to the appended FIG. 1. In particular, advantageous embodiments and aspects of the invention are discussed.

FIG. 1 shows a schematic representation of a damper system of a vehicle.

### DETAILED DESCRIPTION OF THE INVENTION

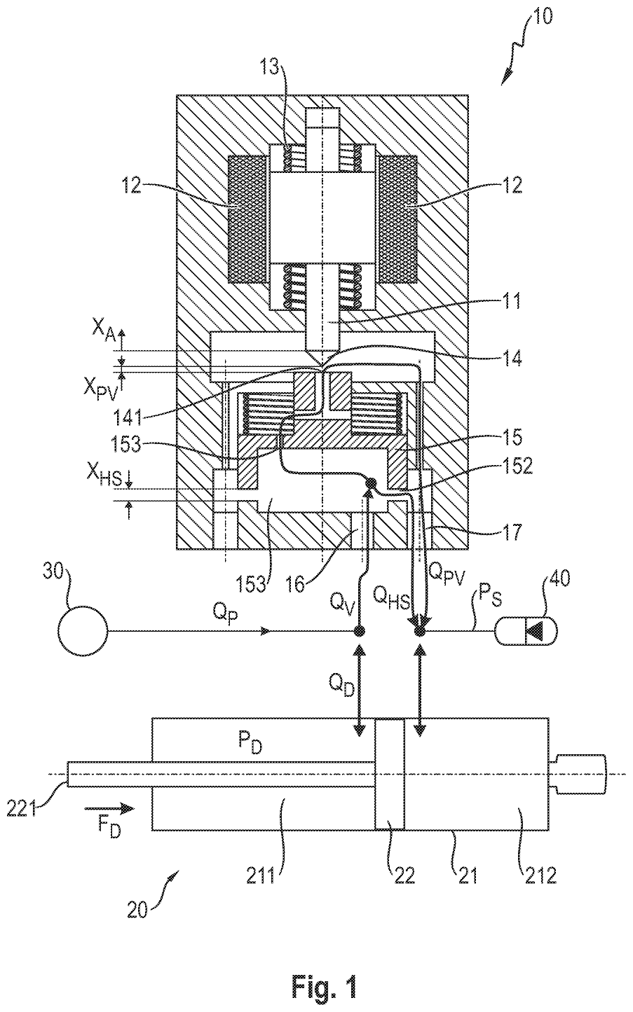

FIG. 1 shows a schematic representation of a damper system of a vehicle, consisting of a damper 20, a damper valve 10, a pump 30, and a pressure reservoir 40. The damper 20 comprises a cylinder 21, which is divided into a first damper chamber 211 and a second damper chamber 212 by a piston 22 having a piston rod 221. The first damper chamber 211 is fluidly connected to the damper valve 10 via a damper valve inlet 16 and the pump 30. The second damper chamber 212 is fluidly connected to the damper 10 via a damper valve outlet 17 and the pressure reservoir 40.

The damper valve 10 comprises an armature 11, which can be moved by an actuator in the form of an electromagnet 12. The position of the armature 11 is referred to as the armature position x_{A}. The armature 11 is in this case preloaded by a spring 13. A pilot valve 14, which defines a pilot valve opening 141 to a main spool 15, is provided on the armature 11. The distance between the pilot valve 14 and the main spool 15 is referred to as the pilot valve opening distance x_{PV}.

The main spool 15 encloses a main spool volume 153 in the damper valve 10, wherein the main spool volume 153 is fluidly connected to the first damper chamber 211 through the damper valve inlet 16. Furthermore, depending on the position of the main spool 15, a main spool opening 152 is provided between the main spool 15 and the housing of the damper valve 10 so that the main spool volume 153 defined by the main spool 15 is fluidly connected to the damper valve outlet 17 through the main spool opening 152. The distance between main spool 15 and the housing of the damper valve 10, which defines the main spool opening 152, is referred to as the main spool opening distance x_{HS}. Through the main spool opening 152, a main spool flow Q_{HS} can thus flow from the main spool volume 153 toward the damper valve outlet 17. Furthermore, the main spool 15 comprises an inlet throttle 151, which likewise represents a fluid connection from the volume enclosed by the main spool 15, toward the pilot valve 14.

The mode of operation of the shown damper valve 10 using the method according to aspects of the invention is considered in more detail below. In this case, a pulling force as a damper force F_{D} is to be applied to the piston 22, which damper force is oriented toward the right in the drawing plane, as indicated by the corresponding arrow on the piston rod 221. Such a force is to be provided to compensate for a disturbance as a result of a movement of the piston 22. To do so, a pressure in the first damper chamber 211 must be increased to a particular target pressure p_{D}. A disturbance of the piston 22 toward the left induces a damper flow Q_{D}, which flows from the first damper chamber 211 toward the damper valve inlet 16. A valve flow Q_{V} flowing through the damper valve inlet 16 is composed of the damper flow Q_{D} and a pump flow Q_{P} provided by the pump 30.

The valve flow Q_{V} results in a pressure in the main spool volume 153 defined by the main spool 15. The pressure applied there is backed up into the first damper chamber 211 via the corresponding pressure lines so that, with a corresponding control, the back pressure caused must correspond to the target pressure p_{D}. This back pressure is determined by the main spool flow Q_{HS}, which arises through the main spool opening 152 as a function of the main spool opening distance x_{HS}. If there is a large main spool opening distance x_{HS} and thus a large main spool opening 152, the back pressure is lower.

The main spool opening distance x_{HS} is in this case defined by a force equilibrium at the main spool 15. As a result of the inlet throttle 151, a low flow passes through the main spool 15 to the pilot valve 14. The force equilibrium of the main spool 15 is accordingly set through the pressure above and below the main spool 15 as well as a preloading of a spring which is provided accordingly above the main spool 15 and preloads the main spool 15 downward. The opening of the inlet throttle 151 is constant so that a particular pressure within the main spool volume 153 and thus a defined target pressure p_{D} in the first damper chamber 211 result in a particular flow through the inlet throttle 151. Depending on the opening of the pilot valve 14, the pressure above the main spool 15 can thus be set. In the case of a large pilot valve opening distance x_{PV}, the pilot valve opening 141 is large, as a result of which a relatively large pilot valve flow Q_{PV} passes through the pilot valve opening 141. Through the pilot valve flow Q_{PV}, the pressure drop in the volume above the main spool 15 is set via the inlet throttle 151. In the case of a high pilot valve flow Q_{PV}, the pressure drop across the inlet throttle 151 is large and the compression force acting downward on the main spool 15 is thus reduced in the volume above the main spool 15. The main spool opening distance x_{HS} is thereby increased. By closing the pilot valve opening 141, i.e., reducing the pilot valve opening distance x_{PV}, the pressure above the main spool 15 can be increased, which leads to a lower main spool opening distance x_{HS} and consequently to a greater back pressure within the main spool volume 153. The pilot valve 14 in turn can be set by the cooperation of the armature 11 and the electromagnet 12.

It should be noted at this point that a static pressure pₛ in the second damper chamber 212 is not critically influenced by the pilot valve flow Q_{PV} and the main spool flow Q_{HS}, which flow from the damper valve outlet 17, and is kept constant by the pressure reservoir 40.

According to the method according to aspects of the invention, based on the illustrated mode of operation of the damper valve 10, the target pressure p_{D}, required for the target damper force F_{D}, in the first damper chamber 211 of the damper 20 is determined first. For this purpose, the static pressure pₛ in the second damper chamber 212 and the surface of the piston 22 are considered. Subsequently, the valve flow Q_{V} is determined based on the damper flow Q_{D} and the pump flow Q_{D}. In this case, the pump flow Q_{D} is preferably ascertained as a function of the target force F_{D} to be provided, of a driving situation of the vehicle, and/or of a damper movement.

Furthermore, the main spool opening distance x_{HS} required to generate the back pressure in the main spool volume 153 and thus the corresponding target pressure p_{D} in the first damper chamber 211 is calculated. In addition, the pilot valve flow Q_{PV}, which flows out of the main spool volume 153 via the inlet throttle 151, for the corresponding back pressure in the main spool volume 153 is determined. This preferably takes place with the aid of a hydraulic model of the inlet throttle 151. Subsequently, the pilot valve opening distance x_{PV} is determined, which is necessary in order to establish the force equilibrium at the main spool 15 in order to set the target main spool opening distance x_{HS}. The armature position x_{A} required for this purpose is furthermore calculated from the sum of the pilot valve opening distance x_{PV} and the main spool opening distance x_{HS}. Preferably, in this case, a known offset of the damper valve, which can be predetermined as the valve setting, is furthermore taken into account.

In order to ultimately generate the target pressure p_{D} in the first damper chamber 211, the electromagnet 12 is subsequently controlled in such a way that the armature 11 moves to the calculated armature position x_{A}. This method enables a corresponding control of the damper force during the detection of the actual force of the damper 20. The actual force is preferably calculated via a hydraulic model from pressures measured at the pump 30, from the damper movement, and from the oil temperature. On the basis of the target-actual force deviations, the magnetic force of the electromagnet 12 for setting the armature position x_{A} can be adjusted accordingly.

The magnetic force necessary for the setting of the armature position x_{A} is calculated from a force equilibrium at the armature 11. Acting on the armature 11 due to the pilot valve flow Q_{PV} at the pilot valve 141 are a compression force from below upward, the magnetic force itself downward, and the spring force of the spring 13 proportionally to the armature position x_{A}. This force equilibrium can be changed according to the magnetic force to be set, by specifying the armature position x_{A}. Deviations between the target and actual forces are directly applied to the magnetic force via a PI controller, whereby the armature position x_{A} is readjusted. In the last step, the magnetic force is converted into a magnet valve current. This conversion preferably takes place with a characteristic map.

What is claimed:

1. A method for operating a damper valve of a damper, wherein the damper valve comprises a pilot valve for controlling a main spool, wherein the method comprises:
determining a target pressure (F_{D}) necessary for a target damper force (p_{D}) in a first damper chamber of the damper;
determining a valve flow (Q_{V}) through a damper valve inlet of the damper valve on the basis of a damper flow (Q_{D}), generated by a damper movement, from the first damper chamber and on a basis of a measured pump flow (Q_{P}) of a pump;
determining a main spool opening distance (x_{HS}) in such a way that, with an applied main spool flow (Q_{HS}) through the main spool opening distance (x_{HS}), the target pressure (p_{D}) is present as a back pressure in the first damper chamber;
determining a pilot valve flow (Q_{PV}), which, at the target pressure (p_{D}) to be set, passes via an inlet throttle in the main spool to the pilot valve and at which the main spool is in a force equilibrium;
determining a pilot valve opening distance (x_{PV}) on the basis of the pilot valve flow (Q_{PV});
determining an armature position (x_{A}) on the basis of the main spool opening distance (x_{HS}) and the pilot valve opening distance (x_{PV}); and
setting the armature position (x_{A}) by way of an actuator.

2. The method according to claim 1, wherein an actual force of the damper is furthermore determined on the basis of pressures ascertained at the pump, of a damper movement, and/or of a temperature of a damper medium.

3. The method according to claim 2, wherein the armature position (x_{A}) is controlled on the basis of a deviation of the predetermined target force (F_{D}) and the measured actual force.

4. The method according to claim 1, wherein the actuator is an electromagnet and a magnetic force necessary for the armature position (x_{A}) to be set is determined on the basis of a force equilibrium at an armature.

5. The method according to claim 4, wherein a determination of a magnet valve current, which leads to a magnetic force applied by the electromagnet to the armature, is determined on the basis of at least one characteristic map.

6. The method according to claim 1, wherein a specification of the pump flow (Q_{P}) is determined as a function of the target force (F_{D}) to be provided, of a driving situation of a vehicle comprising the damper, and/or of a damper movement.

7. The method according to claim 1, wherein the target pressure (p_{D}) is determined based on a static pressure (pₛ) in a second damper chamber, a target damper force (F_{D}) to be set, and a piston surface between the first damper chamber and the second damper chamber.

8. The method according to claim 7, wherein the static pressure (pₛ) is set as a function of an ambient temperature and a position of a piston in a cylinder of the damper.
